(19) United States
(12) Patent Application Publication
(10) Pub. No.: US 2013/0203476 A1
(43) Pub. Date: Aug. 8, 2013

(54) LUCKY 38 BACCARAT SIDE BET

(71) Applicant: James Thomas Kenny, Shorewood, IL (US)

(72) Inventor: James Thomas Kenny, Shorewood, IL (US)

(21) Appl. No.: 13/754,891

(22) Filed: Jan. 30, 2013

Related U.S. Application Data
(60) Provisional application No. 61/633,062, filed on Feb. 6, 2012.

(51) Int. Cl. G07F 17/32; A63F 3/00

(52) U.S. Cl. CPC G07F 17/3293; A63F 3/00157
USPC 463/12; 463/11; 273/274

(57) ABSTRACT

A method of a baccarat game, in which, in addition to a normal play of the game, a Customer will be given the option to make an additional side bet. Any time a Customer has made a valid side bet wager and a “38” hit/stand game rule is implemented, then the Customer wins according to the posted pay scale payoffs.

### RELATED APPLICATION

This application claims the benefit of U.S. Provisional Application Ser. No. 61/633,062 dated 6 FEB 2012 under 35 U.S.C. 119(e).

### FIELD

This disclosure relates to systems and methods of providing, conducting and modifying wagering games. In particular, the disclosure relates to systems and methods for providing and conducting a modified Baccarat game.

### BACKGROUND

Baccarat is a popular and well-established casino game where a dealer presents two hands sides, respectively called “Player hand” and “Banker hand.” Two hand sides are dealt, where the hands are evaluated as to which side (Player hand or Banker hand) has the highest total single-digit result, when the cards within each hand are tallied. For example, the hand 2-8-6 adds up to 16, but the hand is considered to be a six-value hand, and will lose to the hand Queen-King-9, which tallies up to a nine value. Customers may wager on either hand side to win, or may make a separate “Tie” bet, indicating that the Customer believes that the upcoming round of play will result in a Tie.

### BRIEF DESCRIPTION

In one aspect, a method and apparatus for playing a baccarat-type card game overcomes limitations associated with conventional casino baccarat games such as repetitiveness, lack of multiple odds, and the like. In a further aspect, a baccarat-type card game incorporates a variable payoff based on a side wager as to whether the hit/stand “38” rule was used and to pay the Customer according to the makeup of the Banker hand and the Player hand if such rule was used. The side bet may also be referred to as the “Lucky 38” side bet.

A casino game is provided that can be played on existing baccarat tables with minor side bet placement identification markings on the layout and different printed rules. The game according to the disclosure is a Baccarat derivative or Mini-Baccarat derivative, wherein there are several potential payouts in addition to normal play of the game. In one aspect, a computer-accessible medium includes processor-readable instructions for a betting system for baccarat, the processor-readable instructions capable of directing a processor to determine whether or not a narrow range of hands stored in a memory had won, tied, or lost—regardless of a margin stored in the memory.

In another aspect, a method of playing a wagering game includes a Customer selecting one of a Player hand and a Banker hand and placing a base game bet on the selected hand to participate in a base game, a Customer selecting an optional side bet to participate in a bonus game, a dealer dealing at least one Player hand and at least one Banker hand according to a first set of game rules, a dealer continuing the dealing of additional cards to either the Player hand or the Banker hand according to the first set of game rules, resolving the base card game according to the first set of game rules, determining if the base game has met the requirements of the hit/stand rule to qualify for the bonus payout, resolving the bonus payout according to the makeup of the cards in the qualifying hand as displayed in a second set of rules.

In yet another aspect, a method of playing a wagering game includes a Customer having the option of placing a wager on either one of two hands, the two hands referred to as a Player hand and a Banker hand the Customer placing the wager on one of two hands, that one of two hands on which a wager is placed becoming the wagered hand, an initial hand of at least one card being dealt as a Player's hand and at least one card being dealt as the Banker's hand, finishing the dealing of the hand according to a predetermined set of game rules and evaluating the finished hand to determine if a predetermined hit/stand game rule was used to qualify for a payout, providing an award to the Customer who bet the bonus bet if a qualifying hit/stand rule was met.

In a further aspect a gaming machine includes a processor, a memory operably coupled to the processor, and a display, in which the processor has instructions that are operable to receive into the memory from a dealer a representation of a wagered hand, the wagered hand being a wager on one of two hands, the two hands referred to as a Player hand and a Banker hand, transmit from the memory to the dealer a representation of an initial hand of at least one card as a Player hand, transmit from the memory to the dealer a representation of at least one card being dealt as the Banker's hand, transmit from the memory to the dealer a representation of the hand according to a predetermined set of game rules, evaluate a finished hand to determine if a predetermined hit/stand game rule was used to qualify for a payout and provide an award to the Customer who bet the bonus bet if a qualifying hit/stand rule was met.

A gaming table including a printed Player bet area, a printed Banker bet area, a printed Tie betting area, and a printed “Lucky 38” bonus bet area.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a diagram illustrating an overview of an implementation;

FIG. 2 is a block diagram of a hardware and operating environment, according to an implementation; and

FIG. 3 is a block diagram of a mobile device, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

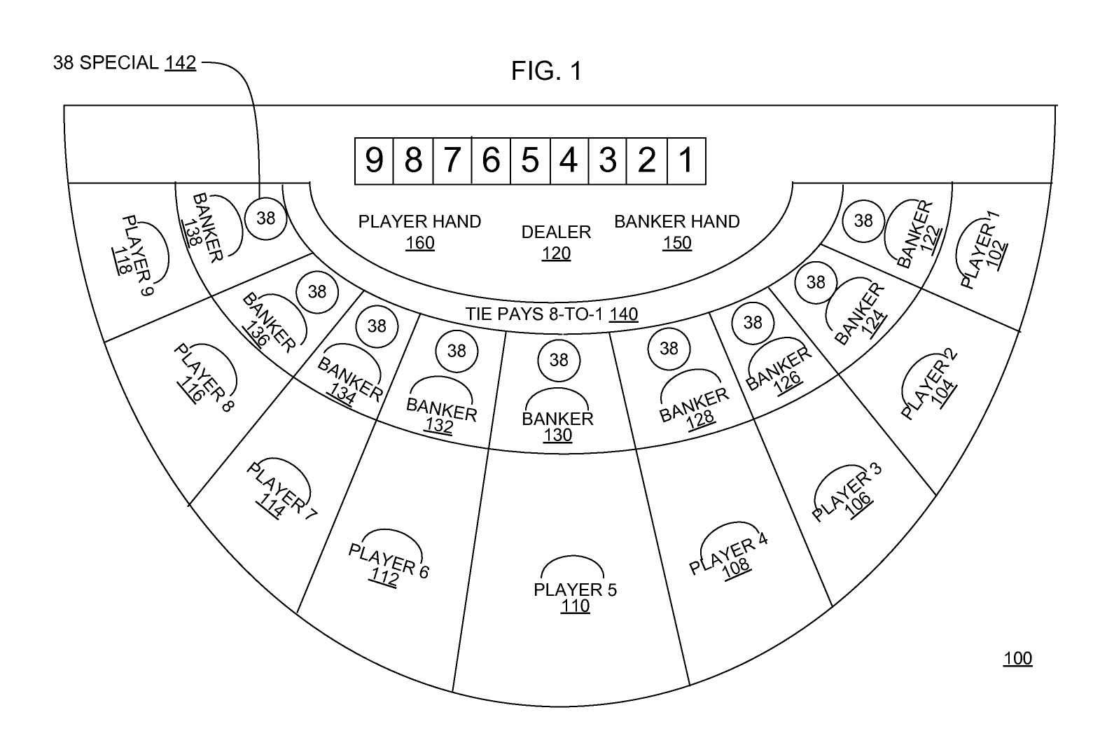

FIG. 1 shows 9 spot baccarat layout that includes a Player Betting Area (102, 104, 106, 108, 110, 112, 114, 116 and 118), a Dealer area 120, Banker Betting Area (122, 124, 126, 128, 130, 132, 134, 136, 138), a Tie betting area 140 and a “Lucky 38” bet 142.

There are a number of variations of the basic game of baccarat, and the game is sometimes referred to in its various forms as Baccarat-Chemin-de-Fer, Baccarat a deux tableaux, Mini-Baccarat, and the like. The rules may vary slightly, and rules may vary from casino to casino, but the underlying game is the same. The underlying game is a competition between two hands, usually referred to as the Banker hand 150 and the Player hand 160. All Customers at the table can place wagers in the game by receiving a hand of cards. Initially, two cards are dealt to the Player hand and the Banker hand (150). Each initial or partial two-card hand is reviewed by the Banker hand (150) and the Player hand (160). The results of the competition are determined by how close the point total (explained in detail later) is to a value of nine. Two card hands with a point total of 8 or 9 are naturals. Point totals are based on the added face value of the cards, with the values of the cards being Ace-1, 2-2, 3-3, 4-4, 5-5, 6-6, 7-7, 8-8, 9-9, 10=0, Jack=0, Queen=0, and King=0. Only the last digit of the sum of the point values of the cards is operative in the play of the game. For example, a total value of the cards (both with the original hand or partial hand) would be read as 10-0, 11-1, 12-2, 13-3, 14-4, 15-5, 16-6, 17-7, 18=8, 19=9, 20=0, etc. A Customer usually has the option on playing (wagering on) either the Player hand or the Banker hand, or a Tie. This is accomplished by placing the wager in a designated space for a wager on the Banker's hand or the Player hand or a Tie. A commission is usually extracted from the winning bets on the Banker's hand (e.g., 5% of the winning bet on the banker's hand), because the Banker hand 150 usually wins more often than the Player hand 160. No commissions are paid to the house when the Customer bets on the Player hand. There may also be a separate wager placed on the occurrence that the Banker hand and the Player hand will Tie. Depending on the odds provided by the house (usually from 8:1, 9:1 or 10:1), the house advantage is between 4.5% and 15%.

There are just two principal bets to make: Banker hand 150 or Player hand 160-plus the Tie. Some casinos let the Customer deal the cards in turn and others have a casino dealer to deal the cards. In online Baccarat the cards are dealt automatically by a virtual dealer.

Each Customer including the Customer dealing, may bet on either Banker hand 150 or the Player hand 160 but it is customary for the dealer to bet on Banker hand 150. Customer may opt not to deal, passing the ‘Shoe’. The shoe remains with one Customer as long as the Banker hand 150 wins. If Player hand 160 wins, the shoe passes on to the next Customer.

Two hands are dealt and you bet which one will win, or that they will Tie. It is just like betting on Black or Red at roulette, and the payoff is even money, 1:1 (except for the Tie, which pays 8-1 or 9-1). The only difference between the Banker hand bet and Player hand bet is a win on Banker hand 150 in some variations of Baccarat will cost a 5% commission or tax levied by the casino the in-built advantage.

The reason for taxing the Banker hand (150) is because it has been established that over an 8-deck cards play on average the Banker hand (150) will win three to four hands more than the Player hand (160).

Each hand consists of a minimum of two and a maximum of three cards. The person dealing will put two cards, face down, tucked under the shoe, and give the Customer with the largest bet on the Player hand (160) the other two cards, face down.

The Player hand (160) bettor then looks at the cards and gives them back to the Customer who is dealing. Then the Customer who is dealing will turn over the cards of both hands while one of the casino dealers will announce the results and the winner.

If either hand has a total of 8 or 9 (nine is the highest), then it is called a ‘Natural’ and no more cards are dealt. If it is not a natural, then depending on the value of each hand the casino dealer may instruct the card dealer to deal a third card. The decision when to deal a third card follows precise set rules used by all casinos.

Once dealing is completed, the hand with the highest count wins. The paying casino dealers will collect the losing bets first and then pay the winning ones. The Customer who actually deals the cards is not responsible for the payouts. He is just like any other Customer, playing against the casino.

### The Rules

Baccarat is played from a six-deck or an eight-deck shoe. All face cards and 10s have no value. Cards less than 10 are counted at face value, Aces are worth 1. Suits don't matter except in some bonus bets. Only single digit values are valid. Any count that reaches a double digit drops the left digit. 15 is counted as 5 and 25 is also counted as 5.

To start, the Customers bet either on Banker hand (150), Player hand (160), or, Tie. The card dealer gives two cards each; first to the Player hand (160) and then the Banker hand (150). The object of the game is to bet on the hand that you think will have the highest total value.

A third card may be dealt to either or both the Player hand 160 and the Banker hand 150 based on the following three-card-rules. It is not necessary to learn these rules to play, they are compulsory decisions and therefore automatic. Only on rare occasions a mistake is made:

Player's Third-Card-Rule:

If either the Player hand 160 or the Banker hand 150 have a total of 8 or 9 on the first two cards no further cards are drawn. The resulting hand is called a natural and the hand is over.

If the Player's hand (160) total is less than or equal to 5 the Player hand draws a third card.

If the Player hand (160) does not draw a third card, then the Banker's hand 150 hand stands on 6 or more and takes a third card on a total of 5 or less. If the Player hand (160) does take a third card then the Banker's hand 150 third-card-rule below will determine if the Banker hand takes a third card.

Banker's Third-Card-Rule:

If the Banker's hand total is 2 or less then banker draws a card, regardless of what the Player's hand third card is.

(38) If the Banker hand total is 3 then the Banker hand draws a third card unless the Player's hand third card was an 8.

(27) If the Banker hand 150 total is 4 then the Banker's hand draws a third card unless the Player's hand third card was a 0, 1, 8, or 9.

(47) If the Banker hand 150 total is 5 then the Banker's hand draws a third card if the Player's hand third card was 4, 5, 6, or 7.

(67) If the Banker's hand total is 4 and the Banker's hand draws a third card, if the third card is a 2, 3, 4, 5, 6, 7. If the Banker's hand total is 6 then the banker draws a third card if the Player's hand third card was a 6 or 7.

If the Banker hand 150 total is 7 then the banker stands.

House Advantage

Banker 1.17%

Player 1.36%

Tie 14.12% at 8:1 payout

In one example of the present disclosure, the variable payoff is determined according to the following schedule:

Banker Wins 3-1 Player Suited, and Banker Suited 10,000 for 1

Banker Wins 3-1, not both suited 300 for 1. All cards of either the Player hand or the Banker hand must be of the same suit to be suited.

Banker Wins 3-0 or 3-2 200 for 1

Banker 3 Ties or loses 100 for 1

In another example of the disclosure a one dollar bonus bet on the progressive bonus feature would pay the following:

Banker Wins 3-1 Suited 10,000* for all bettors (aggregate)

Banker Wins 3-1, not suited 500 for 1 to each bettor

Banker Wins 3-0 or 3-2 100 for 1 to each bettor

Banker 3 Ties or Loses 50 for 1 to each bettor

*Seed amount the casino puts up for the progressive

As would be apparent to those skilled in the relevant art, the disclosure can be embodied in a wide variety and forms of media, but not limited to, single player slot video machines, multi-player slot video machines, electronic games and devices, lottery terminals, scratch-card formats, software as well as in-flight, home and Internet entertainment. In addition, the disclosure can be readily implemented as a computer program product (e.g., floppy disk, compact disc (CD), etc.) comprising a computer readable medium having control logic recorded therein to implement the features of the disclosure as described in relation to the other preferred embodiments. Control logic can be loaded into the memory of a computer and executed by a central processing unit (CPU) to perform the operations described herein.

While this disclosure has been described in connection with what is presently considered to be the most practical and preferred embodiments, it is to be understood that the disclosure is not to be limited to the disclosed embodiments. The “38” rule is the basis of the preferred embodiment but any of the other rules of the game could form the basis for the bonus payouts in either a “for one” format or as a progressive. Variations in the construction of the table, software, hardware, gaming apparatus box design and the like are considered to be within the skill of the ordinary artisan and are contemplated in the scope of the disclosure. The claims are intended to cover various modifications and equivalent arrangements included within the spirit and scope of the appended claims. All variations of the disclosure can be performed manually.

### Hardware and Operating Environment

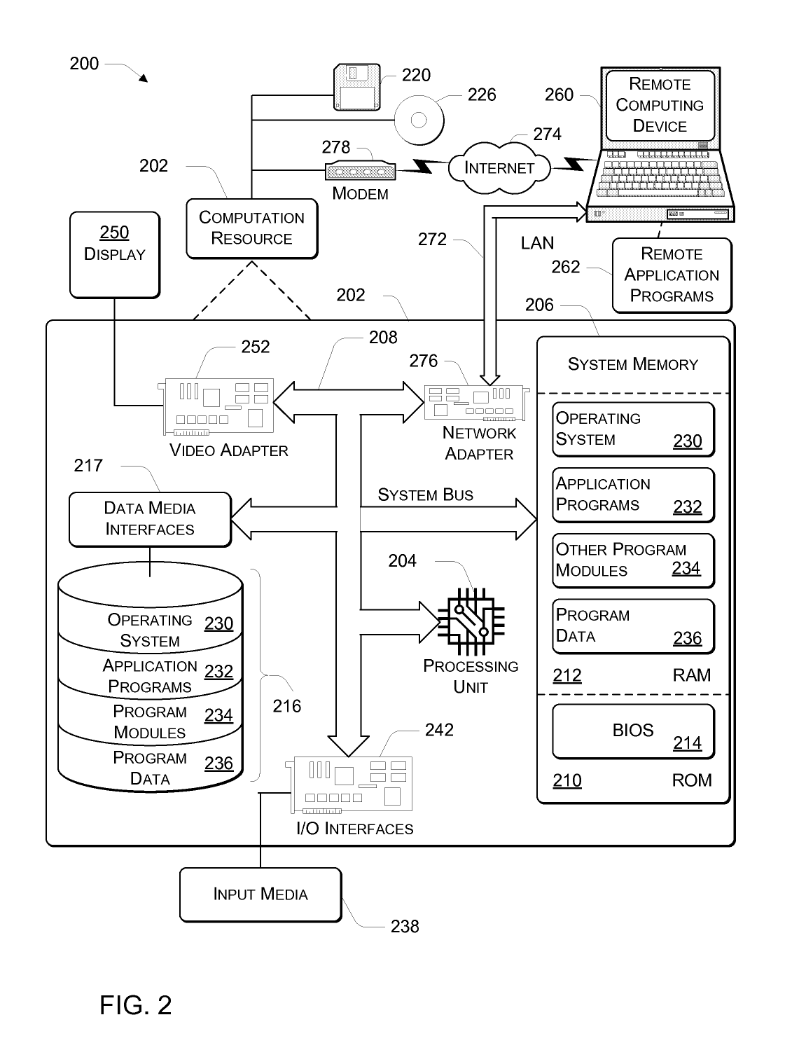

FIG. 2 is a block diagram of a hardware and operating environment 200 in which different implementations can be practiced. The description of FIG. 2 provides an overview of computer hardware and a suitable computing environment in conjunction with which some implementations can be implemented. Implementations are described in terms of a computer executing processor-executable instructions. However, some implementations can be implemented entirely in computer hardware in which the processor-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 2 illustrates an example of a general computer environment 200 useful in the context of the environment of FIG. 1, in accordance with an implementation of the disclosed subject matter. The general computer environment 200 includes a computation resource 202 capable of implementing the processes described herein. It will be appreciated that other devices can alternatively include more components, or fewer components, than those illustrated in FIG. 2.

The illustrated operating environment 200 is only one example of a suitable operating environment, and the example described with reference to FIG. 2 is not intended to suggest any limitation as to the scope of use or functionality of the implementations of this disclosure. Other well-known computing systems, environments, and/or configurations can be suitable for implementation and/or application of the subject matter disclosed herein.

The computation resource 202 includes one or more processors or processing units 204, a system memory 206, and a bus 208 that couples various system components including the system memory 206 to processor(s) 204 and other elements in the environment 200. The bus 208 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 206 includes nonvolatile read-only memory (ROM) 210 and random access memory (RAM) 212, which can or can not include volatile memory elements. A basic input/output system (BIOS) 214, containing the elementary routines that help to transfer information between elements within computation resource 202 and with external items, typically invoked into operating memory during start-up, is stored in ROM 210.

The computation resource 202 further can include a non-volatile read/write memory 216, represented in FIG. 2 as a hard disk drive, coupled to bus 208 via a data media interface 217 (e.g., a SCSI, ATA, or other type of interface); a magnetic disk drive (not shown) for reading from, and/or writing to, a removable magnetic disk 220 and an optical disk drive (not shown) for reading from, and/or writing to, a removable optical disk 226 such as a CD, DVD, or other optical media.

The non-volatile read/write memory 216 and associated computer-readable media provide nonvolatile storage of processor-readable instructions, data structures, program modules and other data for the computation resource 202. Although the exemplary environment 200 is described herein as employing a non-volatile read/write memory 216, a removable magnetic disk 220 and a removable optical disk 226, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 216, magnetic disk 220, optical disk 226, ROM 210, or RAM 212, including an operating system 230, one or more application programs 232, other program modules 234 and program data 236. Examples of computer operating systems conventionally employed for some types of three-dimensional and/or two-dimensional medical image data include the NUCLEUS® operating system, the LINUX® operating system, and others, for example, providing capability for supporting application programs 232 using, for example, code modules written in the C++® computer programming language.

A user can enter commands and information into computation resource 202 through input devices such as input media 238 (e.g., keyboard/keypad, tactile input or pointing device, mouse, foot-operated switching apparatus, joystick, touchscreen or touchpad, microphone, antenna etc.). Such input devices 238 are coupled to the processing unit 204 through a conventional input/output interface 242 that is, in turn, coupled to the system bus. A monitor 250 or other type of display device is also coupled to the system bus 208 via an interface, such as a video adapter 252.

The computation resource 202 can include capability for operating in a networked environment using logical connections to one or more remote computers, such as a remote computer 260. The remote computer 260 can be a personal computer, a server, a router, a network PC, a peer device or other common network node, and typically includes many or all of the elements described above relative to the computation resource 202. In a networked environment, program modules depicted relative to the computation resource 202, or portions thereof, can be stored in a remote memory storage device such as can be associated with the remote computer 260. By way of example, remote application programs 262 reside on a memory device of the remote computer 260. The logical connections represented in FIG. 2 can include interface capabilities, a storage area network (SAN, not illustrated in FIG. 2), local area network (LAN) 272 and/or a wide area network (WAN) 274, but can also include other networks.

Such networking environments are commonplace in modern computer systems, and in association with intranets and the Internet. In certain implementations, the computation resource 202 executes an Internet Web browser program (which can optionally be integrated into the operating system 230), such as the “Internet Explorer®” Web browser manufactured and distributed by the Microsoft Corporation of Redmond, Wash.

When used in a LAN-coupled environment, the computation resource 202 communicates with or through the local area network 272 via a network interface or adapter 276. When used in a WAN-coupled environment, the computation resource 202 typically includes interfaces, such as a modem 278, or other apparatus, for establishing communications with or through the WAN 274, such as the Internet. The modem 278, which can be internal or external, is coupled to the system bus 208 via a serial port interface.

In a networked environment, program modules depicted relative to the computation resource 202, or portions thereof, can be stored in remote memory apparatus. It will be appreciated that the network connections shown are exemplary, and other means of establishing a communications link between various computer systems and elements can be used.

A user of a computer can operate in a networked environment using logical connections to one or more remote computers, such as a remote computer 260, which can be a personal computer, a server, a router, a network PC, a peer device or other common network node. Typically, a remote computer 260 includes many or all of the elements described above relative to the computer 200 of FIG. 2.

The computation resource 202 typically includes at least some form of computer-readable media. Computer-readable media can be any available media that can be accessed by the computation resource 202. By way of example, and not limitation, computer-readable media can comprise computer storage media and communication media.

Computer storage media include volatile and nonvolatile, removable and non-removable media, implemented in any method or technology for storage of information, such as processor-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 202.

The implementations described herein generally relate to a mobile wireless communication device, hereafter referred to as a mobile device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

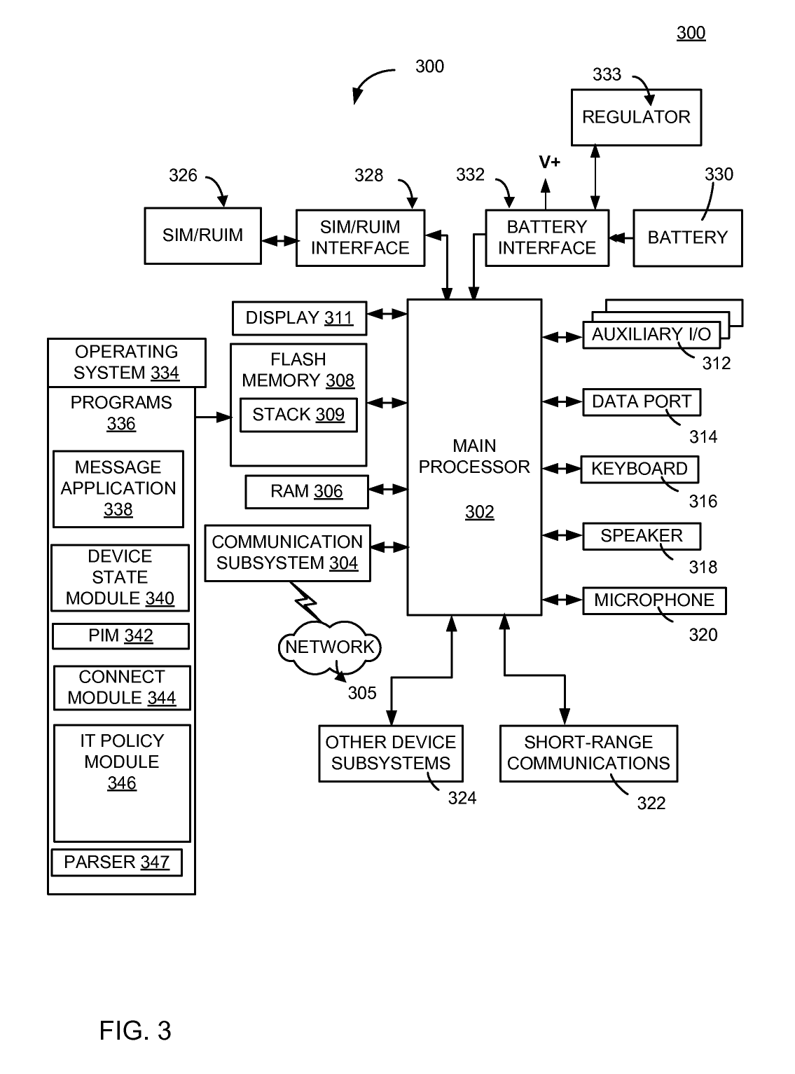

FIG. 3 is a block diagram of a mobile device 300, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Mobile device 300 is one implementation of mobile device 106 in FIG. 1. The mobile device 300 includes a number of components such as a main processor 302 that controls the overall operation of the mobile device 300. Communication functions, including data and voice communications, are performed through a communication subsystem 304. The communication subsystem 304 receives messages from and sends messages to wireless networks 305. Other implementations of the mobile device 300, the communication subsystem 304 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 304 with the wireless network 305 represents one or more different Radio Frequency (RF) channels. With newer network protocols, these channels are capable of supporting both circuit switched voice communications and packet switched data communications.

The main processor 302 also interacts with additional subsystems such as a Random Access Memory (RAM) 306, a flash memory 308, a display 310, an auxiliary input/output (I/O) subsystem 312, a data port 314, a keyboard 316, a speaker 318, a microphone 320, short-range communications 322 and other device subsystems 324. The configuration data 108, the diagnostic results 112 and the calibration results 116 is received by the communication subsystem 304 and transferred by the main processor 302 to the flash memory 308. The diagnostic instructions 110 and the calibration instructions 114 is also transferred by the main processor 302 from the flash memory 308 through the cable 102.

Some of the subsystems of the mobile device 300 perform communication-related functions, whereas other subsystems may provide “resident” or on-device functions. By way of example, the display 311 and the keyboard 316 may be used for both communication-related functions, such as entering a text message for transmission over the wireless network 305, and device-resident functions such as a calculator or task list.

The mobile device 300 can transmit and receive communication signals over the wireless network 305 after required network registration or activation procedures have been completed. Network access is associated with a subscriber or user of the mobile device 300. To identify a subscriber, the mobile device 300 requires a SIM/RUIM card 326 (i.e. Subscriber Identity Module or a Removable User Identity Module) to be inserted into a SIM/RUIM interface 328 in order to communicate with a network. The SIM card or RUIM 326 is one type of a conventional “smart card” that can be used to identify a subscriber of the mobile device 300 and to personalize the mobile device 300, among other things. Without the SIM card 326, the mobile device 300 is not fully operational for communication with the wireless network 305. By inserting the SIM card/RUIM 326 into the SIM/RUIM interface 328, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 326 includes a processor and memory for storing information. Once the SIM card/RUIM 326 is inserted into the SIM/RUIM interface 328, it is coupled to the main processor 302. In order to identify the subscriber, the SIM card/RUIM 326 can include some user parameters such as an International Mobile Subscriber Identity (IMSI). An advantage of using the SIM card/RUIM 326 is that a subscriber is not necessarily bound by any single physical mobile device. The SIM card/RUIM 326 may store additional subscriber information for a mobile device as well, including datebook (or calendar) information and recent call information. Alternatively, user identification information can also be programmed into the flash memory 308.

The mobile device 300 is a battery-powered device and includes a battery interface 332 for receiving one or more rechargeable batteries 330. In one or more implementations, the battery 330 can be a smart battery with an embedded microprocessor. The battery interface 332 is coupled to a regulator 333, which assists the battery 330 in providing power V+ to the mobile device 300. Although current technology makes use of a battery, future technologies such as micro fuel cells may provide the power to the mobile device 300.

The mobile device 300 also includes an operating system 334 and software components 336 to 346 which are described in more detail below. The operating system 334 and the software components 336 to 346 that are executed by the main processor 302 are typically stored in a persistent store such as the flash memory 308, which may alternatively be a read-only memory (ROM) or similar storage element (not shown). Those skilled in the art will appreciate that portions of the operating system 334 and the software components 336 to 346, such as specific device applications, or parts thereof, may be temporarily loaded into a volatile store such as the RAM 306. Other software components can also be included.

The subset of software applications 336 that control basic device operations, including data and voice communication applications, will normally be installed on the mobile device 300 during its manufacture. Other software applications include a message application 338 that can be any suitable software program that allows a user of the mobile device 300 to transmit and receive electronic messages. Various alternatives exist for the message application 338 as is well known to those skilled in the art. Messages that have been sent or received by the user are typically stored in the flash memory 308 of the mobile device 300 or some other suitable storage element in the mobile device 300. In one or more implementations, some of the sent and received messages may be stored remotely from the device 300 such as in a data store of an associated host system with which the mobile device 300 communicates.

The software applications can further include a device state module 340, a Personal Information Manager (PIM) 342, and other suitable modules (not shown). The device state module 340 provides persistence, i.e. the device state module 340 ensures that important device data is stored in persistent memory, such as the flash memory 308, so that the data is not lost when the mobile device 300 is turned off or loses power.

The PIM 342 includes functionality for organizing and managing data items of interest to the user, such as, but not limited to, e-mail, contacts, calendar events, voice mails, appointments, and task items. A PIM application has the ability to transmit and receive data items via the wireless network 305. PIM data items may be seamlessly integrated, synchronized, and updated via the wireless network 305 with the mobile device subscriber's corresponding data items stored and/or associated with a host computer system. This functionality creates a mirrored host computer on the mobile device 300 with respect to such items. This can be particularly advantageous when the host computer system is the mobile device subscriber's office computer system.

The mobile device 300 also includes a connect module 344, and an IT policy module 346. The connect module 344 implements the communication protocols that are required for the mobile device 300 to communicate with the wireless infrastructure and any host system, such as an enterprise system, with which the mobile device 300 is authorized to interface. Examples of a wireless infrastructure and an enterprise system are given in FIGS. 21 and 22, which are described in more detail below.

The connect module 344 includes a set of APIs that can be integrated with the mobile device 300 to allow the mobile device 300 to use any number of services associated with the enterprise system. The connect module 344 allows the mobile device 300 to establish an end-to-end secure, authenticated communication pipe with the host system. A subset of applications for which access is provided by the connect module 344 can be used to pass IT policy commands from the host system to the mobile device 300. This can be done in a wireless or wired manner. These instructions can then be passed to the IT policy module 346 to modify the configuration of the device 300. Alternatively, in some cases, the IT policy update can also be done over a wired connection.

The IT policy module 346 receives IT policy data that encodes the IT policy. The IT policy module 346 then ensures that the IT policy data is authenticated by the mobile device 300. The IT policy data can then be stored in the flash memory 306 in its native form. After the IT policy data is stored, a global notification can be sent by the IT policy module 346 to all of the applications residing on the mobile device 300. Applications for which the IT policy may be applicable then respond by reading the IT policy data to look for IT policy rules that are applicable.

The IT policy module 346 can include a parser 347, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 346 can determine which applications are affected by the IT policy data and transmit a notification to only those applications. In either of these cases, for applications that are not being executed by the main processor 302 at the time of the notification, the applications can call the parser or the IT policy module 346 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 346 sends an acknowledgement back to the host system to indicate that the IT policy data was received and successfully applied.

Other types of software applications can also be installed on the mobile device 300. These software applications can be third party applications, which are added after the manufacture of the mobile device 300. Examples of third party applications include games, calculators, utilities, etc.

The additional applications can be loaded onto the mobile device 300 through at least one of the wireless network 305, the auxiliary I/O subsystem 312, the data port 314, the short-range communications subsystem 322, or any other suitable device subsystem 324. This flexibility in application installation increases the functionality of the mobile device 300 and may provide enhanced on-device functions, communication-related functions, or both. For example, secure communication applications may enable electronic commerce functions and other such financial transactions to be performed using the mobile device 300.

The data port 314 enables a subscriber to set preferences through an external device or software application and extends the capabilities of the mobile device 300 by providing for information or software downloads to the mobile device 300 other than through a wireless communication network. The alternate download path may, for example, be used to load an encryption key onto the mobile device 300 through a direct and thus reliable and trusted connection to provide secure device communication.

The data port 314 can be any suitable port that enables data communication between the mobile device 300 and another computing device. The data port 314 can be a serial or a parallel port. In some instances, the data port 314 can be a USB port that includes data lines for data transfer and a supply line that can provide a charging current to charge the battery 330 of the mobile device 300.

The short-range communications subsystem 322 provides for communication between the mobile device 300 and different systems or devices, without the use of the wireless network 305. For example, the subsystem 322 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 304 and input to the main processor 302. The main processor 302 will then process the received signal for output to the display 310 or alternatively to the auxiliary I/O subsystem 312. A subscriber may also compose data items, such as e-mail messages, for example, using the keyboard 316 in conjunction with the display 310 and possibly the auxiliary I/O subsystem 312. The auxiliary subsystem 312 may include devices such as: a touch screen, mouse, track ball, infrared fingerprint detector, or a roller wheel with dynamic button pressing capability. The keyboard 316 is preferably an alphanumeric keyboard and/or telephone-type keypad. However, other types of keyboards may also be used. A composed item may be transmitted over the wireless network 305 through the communication subsystem 304.

For voice communications, the overall operation of the mobile device 300 is substantially similar, except that the received signals are output to the speaker 318, and signals for transmission are generated by the microphone 320. Alternative voice or audio I/O subsystems, such as a voice message recording subsystem, can also be implemented on the mobile device 300. Although voice or audio signal output is accomplished primarily through the speaker 318, the display 310 can also be used to provide additional information such as the identity of a calling party, duration of a voice call, or other voice call related information.

Communication media typically embodies processor-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

FIG. 1 can be embodied as shown in FIGS. 2 and 3 as computer hardware circuitry or as a computer-readable program, or a combination of both. In particular, FIG. 1 can be embodied on a display shown in FIGS. 2 and 3

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 200 in FIG. 2, or on at least as many computers as there are components.

### CONCLUSION

A “Lucky 38” baccarat method and system is described. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

1. A method of a wagering game, the method comprising:
receiving into a memory from a dealer a representation of a selected hand that is one of a Player hand and a Banker hand;
receiving into the memory from the dealer a representation of a base game bet on the selected hand to participate in a base card game;
receiving into the memory from the dealer a representation of a selected optional side bet to participate in a bonus game;
transmitting from the memory to the Customer a representation of at least one Player hand and at least one Banker hand according to a first set of game rules;
transmitting from the memory to the Customer a representation of additional cards to either the Player hand or the Banker hand according to the first set of game rules;
resolving the base card game according to the first set of game rules;
determining if the base game has met requirements of a hit/stand rule to qualify for a bonus payout; and
resolving the bonus payout according to a makeup of the cards in a qualifying hand as displayed in a second set of rules.

2. The method of claim 1, wherein the first set of game rules comprises baccarat.

3. The method of claim 1, wherein the second set of game rules comprises baccarat.

4. The method of claim 1, wherein the first set of game rules and the second set of game rules are the same.

5. The method of claim 1, wherein the base game is mandatory.

6. The method of claim 1, wherein the base game is optional.

7. The method of claim 1, wherein the bonus game is mandatory.

8. The method of claim 1, wherein the bonus game is optional.

9. The method of claim 1, wherein the base and bonus games are resolved according to the rules of baccarat and the qualifying hit/stand rule is the “38” rule.

10. The method of claim 1, wherein the qualifying hit/stand rule is not the “38” rule.

11. The method of claim 1, wherein the base game is mini baccarat, and the bonus payouts are awarded according to the following schedule.

12. The method of claim 1 wherein resolution of the bonus game bet comprises payouts within the range of 100 for 1 to 10,000 for 1.

13. A gaming machine comprising:
a processor;
a memory operably coupled to the processor; and
a display,
the processor having instructions operable to:
receive into the memory a representation of a wagered hand, the wagered hand being a wager on one of two hands, the two hands referred to as a Player hand and a Banker hand;
transmit from the memory to the dealer a representation of an initial hand of at least one card as a Player hand;
transmit from the memory to the dealer a representation of at least one card being dealt as the Banker's hand;
transmit from the memory to the dealer a representation of the hand according to a predetermined set of game rules;
evaluate a finished hand to determine if a predetermined hit/stand game rule was used to qualify for a payout; and
provide an award to the Customer who bet the bonus bet if a qualifying hit/stand rule was met.

14. The gaming machine of claim 13 wherein the wagering game comprises a baccarat-type wagering game.

15. The gaming machine of claim 14 wherein the award to the Customer is based on the base game using the “38” rule.

16. The gaming machine of claim 15 wherein the award is increased according to the makeup of the cards in each the Banker hand and the Player hand.

17. The gaming machine of claim 15, wherein the lowest payout is for a Banker hand of two cards with a Player hand of three cards and the Banker hand losing or a Tie.

18. The gaming machine of claim 15, wherein the Banker win of 3 over 1 with both the Banker hand and Player hands suited comprises the highest payout.

19. A gaming table comprising:
a printed Player bet area;
a printed Banker bet area;
a printed Tie betting area; and
a printed “Lucky 38” bonus bet area.

20. The gaming table of claim 19, further comprising:
a 9 spot baccarat layout.
